(19) United States
(12) Patent Application Publication
(10) Pub. No.: US 2022/0107581 A1
(43) Pub. Date: Apr. 7, 2022

(54) IMAGE FORMING APPARATUS

(71) Applicant: KYOCERA Document Solutions Inc., Osaka (JP)

(72) Inventors: Minoru Wada, Osaka (JP); Masahito Ishino, Osaka (JP); Takahisa Nakaue, Osaka (JP); Yukari Ota, Osaka (JP); Tomohiro Tamaki, Osaka (JP)

(21) Appl. No.: 17/449,068

(22) Filed: Sep. 27, 2021

(30) Foreign Application Priority Data
Oct. 6, 2020 (JP) 2020-168983

(51) Int. Cl. G03G 15/06; G03G 15/02

(52) U.S. Cl. CPC G03G 15/065; G03G 15/0266

(57) ABSTRACT

An image forming apparatus includes an image-carrying member, a charging device, an exposure device, and a developing device. The charging device charges a surface of the image-carrying member. The exposure device writes an electrostatic latent image on the surface of the image-carrying member by exposing the charged surface of the image-carrying member. The developing device includes a developing roller and a bias output circuit. The bias output circuit applies a developing bias to the developing roller. A potential VH of a non-exposure portion charged on the surface of the image-carrying member, a potential VL of an exposure portion on the surface of the image-carrying member, and the developing bias VDD meet a relationship of VH−VDD≥2 (VDD−VL). In addition, a difference between the developing bias VDD and the potential VL of the exposure portion (VDD−VL) is 100 V or more.

### INCORPORATION BY REFERENCE

This application is based upon and claims the benefit of priority from the corresponding Japanese Patent Application No. 2020-168983 filed on Oct. 6, 2020, the entire contents of which are incorporated herein by reference.

This disclosure relates to an electrophotographic image forming apparatus.

### BACKGROUND

In the electrophotographic image forming apparatus, for the purpose of cost reduction or downsizing of the apparatus, a cleaner-less method without a mechanism that scraps foreign matter such as remaining toner or paper powder from the surface of a photoconductor may be adopted.

In the above-described image forming apparatus using the cleaner-less method, a developing device collects the remaining toner by electrical suction. In this case, it is important that an electric field between the photoconductor and a developing roller of the developing device is appropriately set, in order to achieve both an image quality and collecting of the foreign matter.

A potential of a non-exposure portion charged on the surface of the photoconductor is set to a predetermined range. It is known that the potential of the non-exposure portion is set to, for example, a range from a value of 100 V higher than a developing bias to a value of 400 V higher than the developing bias. Furthermore, it is known that the potential of the non-exposure portion is set to 750 V or less. This is intended to prevent image defects such as development fog or defects of development density.

### SUMMARY

An image forming apparatus according to one aspect of the present disclosure includes an image-carrying member, a charging device, an exposure device, and a developing device. The charging device charges a surface of the image-carrying member. The exposure device writes an electrostatic latent image on the surface of the image-carrying member by exposing the charged surface of the image-carrying member. The developing device includes a developing roller and a bias output circuit that applies a developing bias to the developing roller, and develops the electrostatic latent image by supplying a developer from the developing roller to the image-carrying member. An area on the surface of the image-carrying member, between a portion where an image of the developer is transferred to an object to be transferred and a portion facing the charging device, corresponds to a non-contact area which does not come into contact with components other than the image-carrying member. A potential VH of the non-exposure portion charged on the surface of the image-carrying member, a potential VL of an exposure portion on the surface of the image-carrying member, and the developing bias VDD meet a relationship of VH−VL≥2 (VDD−VL). In addition, a difference between the developing bias VDD and the potential VL of the exposure portion (VDD−VL) is 100 V or more.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a cross-sectional view of a drum unit and a developing device in the image forming apparatus according to the embodiment.

FIG. 3 is a cross-sectional view of a developing roller in the image forming apparatus according to the embodiment.

FIG. 4 is a table showing a first experimental result of a performance evaluation of the image forming apparatus.

FIG. 5 is a graph showing a relationship between a first potential difference and a second potential difference in the first experimental result of the performance evaluation of the image forming apparatus.

FIG. 6 is a diagram showing a second experimental result of the performance evaluation in the image forming apparatus.

### DETAILED DESCRIPTION

The following describes an embodiment of the present disclosure with reference to the drawings. It should be noted that the following embodiment is an example of a specific embodiment of the present disclosure and should not limit the technical scope of the present disclosure.

[A Configuration of an Image Forming Apparatus 10]

An image forming apparatus 10 according to an embodiment executes a print processing with electrophotography. The print processing is a process of forming an image on a sheet.

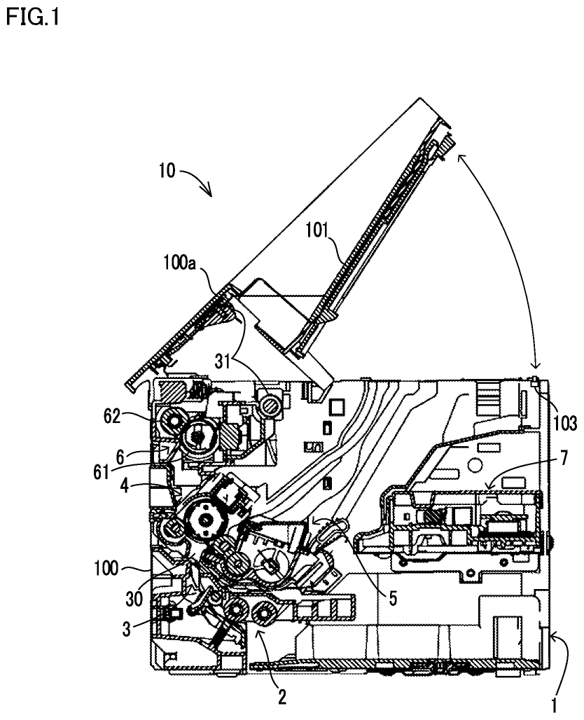

As shown in FIG. 1, the image forming apparatus 10 includes internal devices such as a sheet cassette 1, a sheet feeding mechanism 2, a sheet conveying mechanism 3, a drum unit 4, a developing device 5, a fixing device 6 and an exposure device 7. In addition, the image forming apparatus 10 includes a body 100 that is a housing for accommodating the internal devices.

FIG. 1 shows an opened state of a cover portion 100a that forms an upper surface of the body 100.

The sheet feeding mechanism 2 feeds sheets housed in the sheet cassette 1 one by one to a conveyance path 30 in the body 100. The sheet conveying mechanism 3 includes one or more pair of conveying rollers 31 which convey the sheets along the conveyance path 30.

The sheet conveying mechanism 3 ejects the sheets on which an image is formed, from the conveyance path 30 to a discharge tray 101. The discharge tray 101 is included in a cover portion 100a (see FIG. 1).

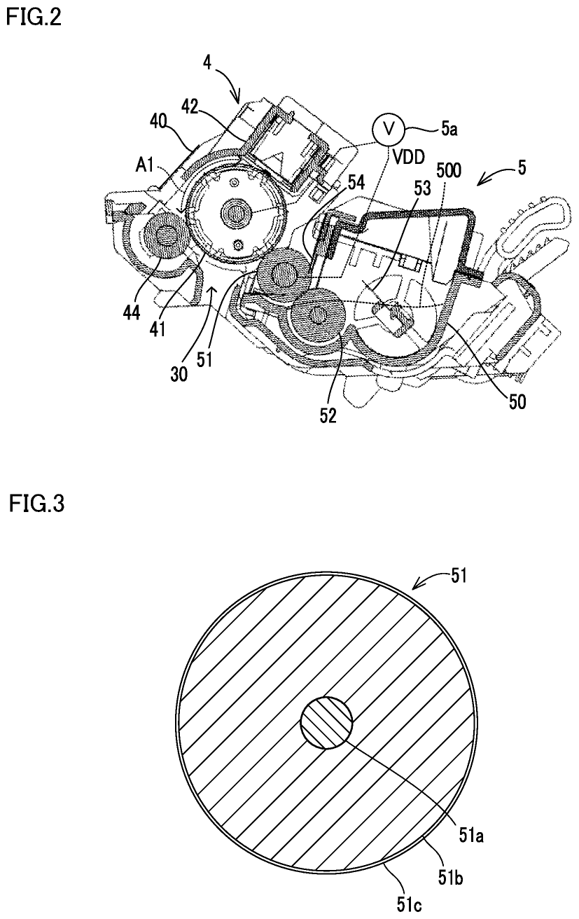

As shown in FIG. 2, the drum unit 4 includes a unit housing 40, a photoconductor 41, a charging device 42, and a transfer roller 44. The unit housing 40 supports the photoconductor 41, the charging device 42, and the transfer roller 44.

The charging device 42 charges a surface of the drum-like photoconductor 41. In this embodiment, the photoconductor 41 is a single-layer organic photoreceptor. The charging device 42 is a scorotron charger equipped with a grid electrode to which a voltage is applied, and guides ions generated by corona discharge to the photoreceptor 41 so as to be charged.

The exposure device 7 writes an electrostatic latent image on the surface of the photoconductor 41 by exposing the surface of the photoconductor 41 with laser light. The electrostatic latent image is developed onto a toner image by the developing device 5. The photoconductor 41 has its surface on which the electrostatic latent image is formed. The photoconductor 41 is an example of an image-carrying member in which the toner image is carried and rotated.

The transfer roller 44 transfers the toner image on the photoconductor 41 to the sheets. In the following description, a toner 500 remaining after the toner image on the surface of the photoconductor 41 is transferred, is referred to as a remaining toner.

The image forming apparatus 10 is an apparatus using a cleaner-less method, without a mechanism that scraps foreign matter such as the remaining toner or paper powder from the surface of the photoconductor 41. That is, an area on the surface of the photoconductor 41, specifically between a portion facing the transfer roller 44 and a portion facing the charging device 42, corresponds to a non-contact area A1 which does not come into contact with components other than the photoconductor 41 (see FIG. 2).

The portion facing the transfer roller 44, on the surface of the photoconductor 41, is a portion where the toner image is transferred to an object to be transferred. In this embodiment, the object to be transferred is each sheet to be conveyed along the conveyance path 30.

The fixing device 6 includes the fixing roller 61 heated by a heater and a pressure roller 62 that presses the sheets to the fixing roller 61. The fixing device 6 heats and pressurizes the toner image transferred to the sheets, so that the toner image is fixed to the sheets.

As shown in FIG. 2, the developing device 5 includes the toner 500, a developing tank 50, a developing roller 51, a feed roller 52, a stirring paddle 53, a regulating blade 54, and a bias output circuit 5a. The toner 500 is an example of a granular developer. The developing tank 50 is a container that stores the toner 500.

The photoconductor 41, the developing roller 51, the feed roller 52, the stirring paddle 53, and the transfer roller 44 are driven by a motor (not shown) to be rotated.

The developing roller 51 is rotatably supported so as to face the photoconductor 41. The developing roller 51 is rotated while carrying the toner 500 on an outer peripheral surface of the developing roller 51. The developing device 5 supplies the toner 500 in the developing tank 50 from the developing roller 51 to the surface of the photoconductor 41, so that the electrostatic latent image on the photoconductor 41 is developed.

As shown in FIG. 3, the developing roller 51 includes a base portion 51a, an elastic layer 51b formed on an outer periphery of the base portion 51a, and a coating 51c formed on an outer peripheral surface of the elastic layer 51b. The base portion 51a is a core member made of metal. The elastic layer 51b is a member made of synthetic rubber. The coating 51c is the outermost layer of the developing roller 51.

The feed roller 52 supplies the toner 500 in the developing tank 50 to the outer peripheral surface of the developing roller 51. That is, the developing roller 51 supplies the toner 500 in the developing tank 50 to the surface of the photoconductor 41 via the feed roller 52.

The stirring paddle 53 stirs the toner 500 in the developing tank 50. The regulating blade 54 comes into contact with the toner 500 on the outer peripheral surface of the developing roller 51, so that the thickness of the toner 500 carried on the developing roller 51 is regulated to a predetermined level.

The bias output circuit 5a applies a developing bias VDD to the developing roller 51. The reference potential of the developing bias VDD corresponds to a potential of the photoconductor 41.

In the image forming apparatus 10 using the cleaner-less method, the developing device 5 collects the remaining toner by electrical suction. In this case, it is important that an electric field between the photoconductor 41 and the development roller 43 is appropriately set, in order to achieve both an image quality and collecting of the foreign matter.

In the following description, a potential of a non-exposure portion charged by an action of the charging device 42 on the surface of the photoconductor 41, is referred to as a reference surface potential VH.

When the reference surface potential VH of the photoconductor 41 and the developing bias VDD are set so as to meet an appropriate relationship, depending on other conditions, an image defect such as a noise point due to defect of collecting of the foreign matter on the surface of the photoconductor 41.

In the following, in the image forming apparatus 10, a configuration suitable for achieving both the image quality and collecting of the foreign matter from the surface of the photoconductor 41 will be described. In the following description, the potential of an exposure portion exposed by the exposure device 7 after a charge due to the action of the charging device 42 on the surface of the photoconductor 41, is referred to as an exposure portion potential VL.

[First Experimental Result]

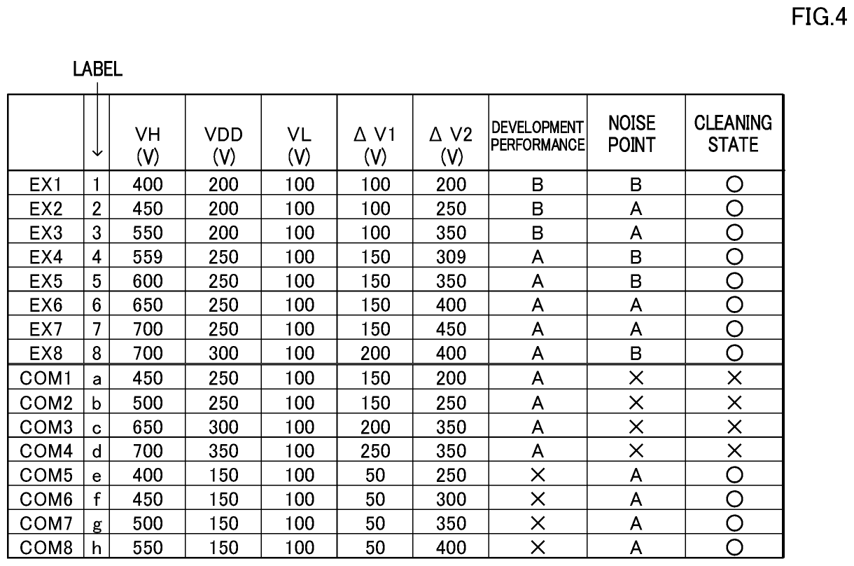

FIG. 4 shows a table of a first experimental result of evaluation of three evaluation points: a development performance, a noise point state, and presence or absence of a cleaning state, for eight examples EX1 to EX8 and eight comparative examples COM1 to COM8 of the image forming apparatus 10 with different conditions of the reference surface potential VH, the developing bias VDD, or the exposure portion potential VL.

In an experimental condition of the first experimental result, a first potential difference ΔV1 is a voltage obtained by subtracting the exposure portion potential VL from the developing bias VDD that is, ΔV1=(VDD−VL). A second potential difference ΔV2 is a voltage obtained by subtracting the developing bias VDD from the reference surface potential VH, that is, ΔV2=(VH−VDD).

FIG. 5 is a graph showing relationship between the first potential difference ΔV1 and the second potential difference ΔV2 in the examples EX1 to EX8 and the comparative examples COM1 to COM8. FIG. 4 shows labels 1 to 8 for identifying the examples EX1 to EX8 and labels a to h for identifying the comparative examples COM1 to COM8. In addition, the graph in FIG. 5 shows the labels corresponding to the plotted points.

In the examples EX1 to EX8 and the comparative examples COM1 to COM8, the coating 51c is a urethane coating. The hardness of the coating 51c that is measured by a micro rubber hardness meter MD-1 is 50 degrees.

In the examples EX1 to EX8 and the comparative examples COM1 to COM8, the developing device 5 executes a development by using a non-magnetic monocomponent contact development system. That is, the toner 500 is a non-magnetic monocomponent developer. The developing device 5 develops the electrostatic latent image by bringing the toner 500 into contact with the surface of the photoconductor 41. A charging polarity of the toner 500 is positive. For example, the toner 500 is a black toner whose main component is a polyester.

In the examples EX1 to EX8 and the comparative examples COM1 to COM8, a peripheral speed of the developing roller 51 is one and a half times in the peripheral speed of the photoconductor 41.

An evaluation result of the examples EX1 to EX8 and the comparative examples COM1 to COM8 is a result when a predetermined test image is formed on a white sheet. The test image is a solid image that is uniformly formed in a maximum color density. The maximum color density is a predetermined density. In the following description, the sheet on which the test image is formed is referred to as a test sheet.

When the density of the test image formed on the test sheet was higher than a first reference density, the development performance was evaluated as A rank. When the density of the test image was within a range from a second reference density that is lower than the first reference density to the first reference density, the development performance was evaluated as B rank. In other cases, the development performance was evaluated as defective.

The A rank and the B rank represent that the development performance is at a sufficient level. The A rank represents that the development performance is at a better level. In a column of the development performance in FIG. 4, a cross mark represents that the development performance was evaluated as defective.

The density of the test image was measured by a predetermined densitometer. The first reference density is the density of 95% relative to that of a black reference member measured by the densitometer. The second reference density is the density of 89% relative to the black reference member measured by the densitometer. The densitometer as used is SPECTRODENSITOMETER FD-7 manufactured by KONICA MINOLTA, INC.

The noise point state was evaluated as defective, when the number of the noise points including black spots existing in a margin area around the test image on the test sheet and white spots existing in the test image exceeded the predetermined allowable number of the noise points.

In addition, the noise point state was evaluated as A rank when the noise point did not exist in the test sheet. The state of the noise point was evaluated as B rank when the allowable number of the noise points existed in the test sheet. In the column of the noise point in FIG. 4, the cross mark represents that the state of the noise point was evaluated as defective.

In addition, the cleaning state means presence or absence of disturbance in the output image, caused by insufficient collection of the foreign matter by the developing device 5. The cleaning state was evaluated by visually reviewing the image on the test sheet. In the column of the cleaning state in FIG. 4, the circle represents that the cleaning state was evaluated as good, and the cross mark represents that the cleaning state was evaluated as defective.

As shown in FIGS. 4 and 5, when the first potential difference ΔV1 is 100 V or less, the development performance is defective (see the comparative examples COMS to COMB).

On the other hand, when the first potential difference ΔV1 is 100 V or more, the development performance is good. However, even when the first potential difference ΔV1 is 100 V or more, in a case in which the second potential difference ΔV2 is less than twice the first potential difference ΔV1, the noise point state and the cleaning state are defective.

As shown in FIGS. 4 and 5, when the first potential difference ΔV1 and the second potential difference ΔV2 meet the relationship of ΔV2≥2ΔV1, and when the first potential difference ΔV1 is 100 V or more, all of the development performance, the noise point state, and the cleaning state are good.

In addition, when the first potential difference ΔV1 and the second potential difference ΔV2 meet the relationship of ΔV2≥2.5ΔV1, the noise point state is better (see examples EX2, 3, 6, and 7). In addition, when the first potential difference ΔV1 is 150 V or more, the development performance is better (see examples EX4 to EX8).

[Second Experimental Result]

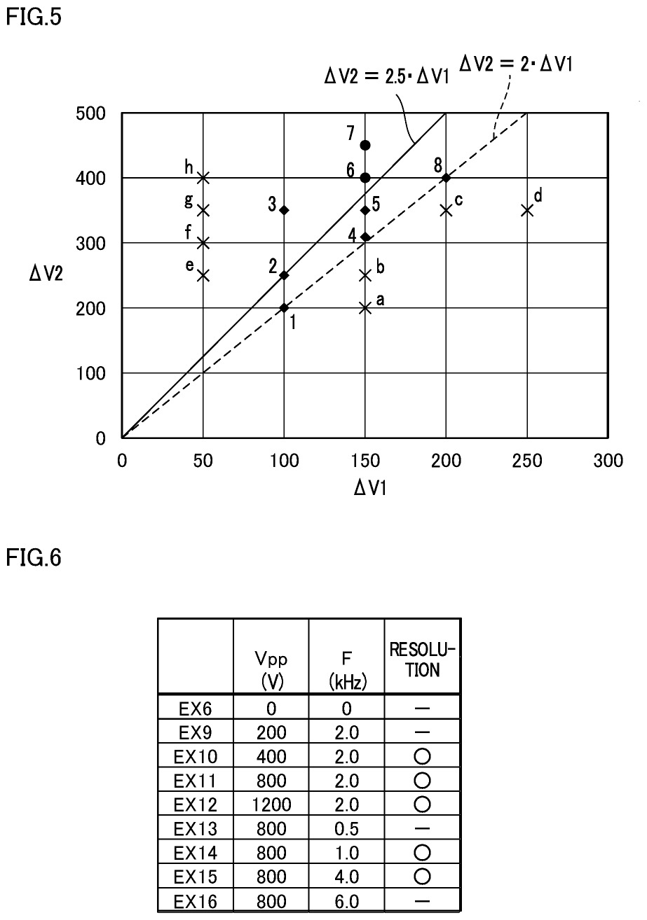

Next, a second experimental result will be described with reference to FIG. 6. FIG. 6 shows the second experimental result in which a resolution of the output image was evaluated for the example EX6 and other eight examples EX9 to EX16 shown in FIGS. 4 and 5.

In the example EX6, the bias output circuit 5a applied only a DC developing bias VDD to the developing roller 51. On the other hand, in the examples EX9 to EX16, the bias output circuit 5a superimposed and applied the DC developing bias VDD and an AC bias, to the developing roller 51.

The examples EX9 to EX16 each have different values for a frequency F or a peak peak value Vpp of the AC bias. The output image is an image outputted at 600 dpi, and includes multiple line images formed by the width of 2 pixels with a space of 2 pixels. The enlarged output image was evaluated by visually reviewing a state of the line images, specifically a cut-off of the line images and a collapse between lines. In FIG. 6, “-” represents that the state of the line images was evaluated to be at the same level as that of the example EX6. The circle represents that the state of the line images was evaluated to be clearly improved from that of the example EX6.

As shown in FIG. 6, when the frequency F of the AC bias that is superimposed on the developing bias VDD is 1 kHz to 4 kHz, and when the peak peak value Vpp of the AC bias is 400 volt to 1200 V, the resolution of the output image is improved.

It is desirable that the peak peak value Vpp of the AC bias is 1000 V or less, in consideration of the cost of the bias output circuit 5a.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image-carrying member;
a charging device that charges a surface of the image-carrying member;
an exposure device that writes an electrostatic latent image by exposing the charged surface of the image-carrying member; and
a developing device including a developing roller and a bias output circuit that applies a developing bias to the developing roller, the developing device that develops an electrostatic latent image by supplying a developer from the developing roller to the image-carrying member, wherein
an area on the surface of the image-carrying member, between a portion where an image of the developer is transferred to an object to be transferred and a portion facing the charging device, corresponds to a non-contact area which does not come into contact with components other than the image-carrying member, wherein
a potential VH of a non-exposure portion charged on the surface of the image-carrying member, a potential VL of an exposure portion on the surface of the image-carrying member, and the developing bias VDD meet a relationship of VH−VDD≥2 (VDD−VL), wherein
a difference between the developing bias VDD and the potential VL of the exposure portion (VDD−VL) is 100 V or more.

2. The image forming apparatus according to claim 1, wherein
the potential VH of the non-exposure portion and the potential VL of the exposure portion meet the relationship of VH−VDD≥2.5 (VDD−VL).

3. The image forming apparatus according to claim 1, wherein
the difference between the developing bias VDD and the potential VL of the exposure portion (VDD−VL) is 150 V or more.

4. The image forming apparatus according to claim 1, wherein
the bias output circuit superimposes and applies the developing bias VDD and an AC bias having a frequency of 1 kHz to 4 kHz and a peak peak value of 400 V to 1200 V, to the developing roller.

5. The image forming apparatus according to claim 1, wherein
the developing device executes a development by using a non-magnetic monocomponent contact development system.
